(19) United States
(12) Patent Application Publication
(10) Pub. No.: US 2003/0145469 A1
(43) Pub. Date: Aug. 7, 2003

(54) Electric hair clipper

(75) Inventors: Hitoshi Ogawa, Inugami gun (JP); Ryo Motohashi, Hikone shi (JP); Noboru Kobayashi, Hikone shi (JP); Hiroaki Shimizu, Hikone shi (JP); Masakazu Kita, Hikone shi (JP); Makoto Nakakura, Hikone shi (JP)

Correspondence Address: GREENBLUM & BERNSTEIN, P.L.C., 1950 ROLAND CLARKE PLACE, RESTON, VA, 20191, US

(73) Assignee: Matsushita Electric Works, Ltd., Osaka (JP)

(21) Appl. No.: 10/353,017

(22) Filed: Jan. 29, 2003

(30) Foreign Application Priority Data
Jan. 30, 2002 (JP) 2002-022476

(51) Int. Cl. B26B 19/02; B26B 19/12

(52) U.S. Cl. 30/210

(57) ABSTRACT

An electric hair cutting device includes a stationary comb-type blade and an oscillating comb-type blade that is driven with a reciprocating movement against the stationary blade. A magnetically-driven oscillation generator is connected to the oscillating blade to impart a reciprocating movement to the blade through a structure that eliminates the need for drive power conversion components.

### BACKGROUND OF THE INVENTION

1. Field of the Invention

The invention relates to cutting devices and more particularly to electric hair clippers and electric beard trimming devices.

2. Description of Related Art

Electric hair clippers used for cutting hair or trimming beards are normally equipped with a stationary comb-type blade and an oscillating comb-type blade which is maintained in contact with one side of the stationary blade. The oscillating blade moves with a horizontal oscillating action against the stationary blade. A shearing action is generated by the leading edges of the oscillating blade sliding over the leading edges of the stationary blade, thus providing a mechanism through which hair between the two leading edges of the blades can be sheared. Hair clippers of this type are conventionally equipped with a drive pin connected to an eccentric shaft driven by a rotating motor installed within the hair clipper casing. A cam groove, which movably joins the eccentric shaft to a fixture on the moving blade, is used to convert the rotating movement of the eccentric shaft to a reciprocating movement which is transferred to the oscillating blade.

### SUMMARY OF THE INVENTION

The present invention provides electric hair clippers equipped with a stationary comb-type blade and an oscillating comb-type blade, the oscillating blade being maintained in contact with a surface of the stationary blade and driven with an oscillating motion that creates a hair shearing mechanism. A magnetically-driven oscillation generator is utilized to impart an oscillating movement to the oscillating blade through a drive member connected to the oscillating generator. It therefore becomes possible to generate an oscillating movement without employing power conversion components.

In regard to the above-described mechanism, it is preferable to directly connect the oscillating blade to the oscillation generator through a drive member.

The above-described oscillation generator incorporates a first drive element connected to the oscillating blade, and a second drive element not connected to the oscillating blade. While both drive elements may oscillate in the same direction, it is preferable that the drive elements oscillate in mutually differing phase, and further preferable that they reciprocate in mutually opposing phase.

Moreover, vibration imparted to the casing, in which the oscillation generator is installed, can be substantially reduced by establishing the combined weight of the first drive element and oscillating blade to a weight approximately equivalent to that of the second drive element, by locating the center of mass of the combined first drive element and oscillating blade at the approximate center of mass of the second drive element, and by locating the combined center of mass of the first drive element and oscillating blade and the center of mass of the second drive element on the axial center of the casing.

It is preferable to connect both drive elements through a spring oriented in the oscillating direction in order to increase the operating efficiency of the two drive elements. In this case at least one of the two drive elements should be employed as the magnetically driven drive member.

Moreover, it is preferable to attach both drive elements to a fixed part through connecting members that allow the drive elements to oscillate in mutually dissimilar phase in relation to a fixed member, and that maintains both drive members in a position where they do not contact the fixed member.

An aspect of the present invention provides an electric hair clipper including a hair shearing mechanism including a comb-shaped stationary blade and an oscillating blade that reciprocates along and in contact with a surface of the stationary blade, and a magnetic oscillation generator that transfers oscillating movement to a drive member connected to the oscillating blade. The oscillating blade may be directly attached to the drive member of the oscillation generator.

According to a further aspect of the present invention, the drive member of the oscillation generator may include a first drive element connected to the oscillating blade, and a second drive element not connected to the oscillating blade, wherein the oscillation generator generates oscillating movement in which the first and second drive elements oscillate in the same direction but in dissimilar phase. The first and second drive elements may oscillate in mutually opposing phase. Additionally, the second drive element may be configured to have sufficient weight to minimize oscillation transmitted to a casing of the hair clipper. Further, the combined weight of the first drive element and the oscillating blade substantially equals the weight of the second drive element.

In a further aspect of the present invention, the combined center of mass of the first drive element and the oscillating blade and the center of mass of the second drive element are both located at substantially the same position. Further, the combined center of mass of the first drive element and the oscillating blade and the center of mass of the second drive element are both located on an axial center of the casing housing the oscillation generator.

The electric hair clipper may further include springs connecting the first and second drive elements and oriented in the oscillating direction of the oscillating blade; and at least one of the first and second drive elements may be a magnetically driven drive member.

According to a further aspect of the present invention, the first and second drive elements may be provided on a fixed member through connecting members, the connecting members providing a mechanism through which the first and second drive elements may oscillate in the same direction but in dissimilar phase. The electric hair clipper may further include a slot provided on a face of the oscillating blade, a drive pin extending from the first drive element and configured to fit into the slot, wherein the first drive element transfers oscillating movement to the oscillating blade.

In a further aspect of the present invention, the electric hair clipper may further include a fixed member including an electromagnet, a frame provided on the fixed member, a first drive element connected to the oscillating blade, a second drive element, the second drive element being substantially box shaped, and the first drive element positioned internally of the box shaped second drive element, connecting members that connect the first and second drive elements to the frame, the connecting members maintaining a gap between the first and second drive elements and the electromagnet, and a pair of springs provided suspended between the first and second drive elements and oriented in the oscillating direction of the oscillating blade. Further, the connecting members may be constructed of an elongation resistant elastic material. The electric hair clipper may further include a pair of support plates provided on the frame, wherein bottom ends of the connecting members are connected to the frame and top ends of the connecting members are connected to the support plates so that the first and second drive elements are suspended in the frame by the connecting members. The first drive element may further include a permanent magnet, the connecting members maintaining the gap between the electromagnet and the permanent magnet. Further, the second drive element may include a permanent magnet, the connecting members maintaining the gap between the electromagnet and the permanent magnet. Further, the first drive element may include a permanent magnet and the second drive element may include a permanent magnet, the connecting members maintaining the gap between the electromagnet and the permanent magnets.

According to a further aspect of the invention, a method of increasing efficiency of an electric hair clipper and minimizing noise and vibration observed by a user of the electric hair clipper is provided. The method may include providing an electric hair clipper having a hair shearing mechanism including a comb-shaped stationary blade and an oscillating blade that reciprocates along and in contact with a surface of the stationary blade, providing a magnetic oscillation generator, and transferring oscillating movement to a drive member connected to the oscillating blade by the magnetic oscillation generator. The method may also include attaching the oscillating blade directly to the drive member of the oscillation generator.

In a still further aspect of the invention, the method may further include providing the drive member with a first drive element connected to the oscillating blade and a second drive element not connected to the oscillating blade, and generating oscillating movement by the oscillation generator such that the first and second drive elements oscillate in the same direction but in dissimilar phase.

In still further aspects of the invention, the method may further include configuring the second drive element to have sufficient weight to minimize oscillation transmitted to a casing of the hair clipper, oscillating the first and second drive elements in mutually opposing phase, and configuring the first drive element, the oscillating blade and the second drive element such that the combined weight of the first drive element and the oscillating blade substantially equals the weight of the second drive element. The method may also include locating the combined center of mass of the first drive element and the oscillating blade and the center of mass of the second drive element at substantially the same position, and locating the combined center of mass of the first drive element and the oscillating blade and the center of mass of the second drive element on an axial center of the casing housing the oscillation generator.

Other aspects of the method of the present invention may also include connecting the first and second drive elements with springs, and orienting the springs in the oscillating direction of the oscillating blade, and/or configuring at least one of the first and second drive elements to have at least one magnetically driven drive member, and/or providing the first and second drive elements on a fixed member through at least one connecting member to permit the first and second drive elements to oscillate in the same direction but in dissimilar phase.

### BRIEF DESCRIPTION OF DRAWINGS

The above and other objects, features and advantages of the present invention will be made apparent from the following description of the preferred embodiments, given as non-limiting examples, with reference to the accompanying drawings in which:

FIG. 1 is an exploded perspective view of the electric hair clipper according to an embodiment of the present invention,

FIG. 2 is a perspective view of the electric hair clipper of FIG. 1;

FIG. 3 is a perspective view of the oscillation generator of the electric hair clipper of FIG. 1;

FIG. 4 is front view of the oscillation generator of FIG. 3;

FIG. 5 is an exploded perspective view of the oscillation generator of FIG. 4;

FIG. 6 is a perspective view of the oscillation generator and oscillating blade block of the electric hair clipper of FIG. 1;

FIG. 7 is a perspective view of the oscillation generator and oscillating blade block of FIG. 6;

FIGS. 8a and 8b are perspective views of an oscillation generator and oscillating blade block according to a second embodiment of the present invention; and

FIGS. 9a and 9b are perspective views of an oscillation generator and oscillating blade block according to a third embodiment of the present invention.

### DETAILED DESCRIPTION OF THE INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description is taken with the drawings making apparent to those skilled in the art how the forms of the present invention may be embodied in practice.

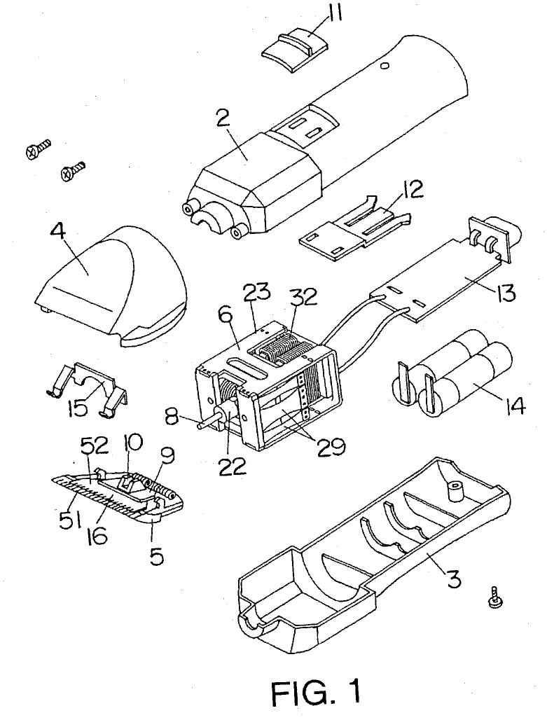

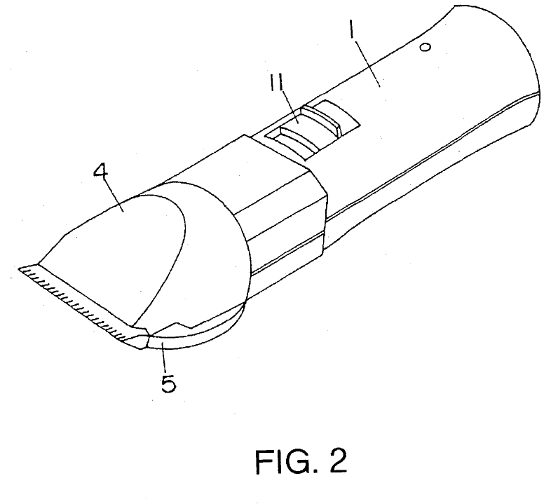

FIG. 1 is an exploded perspective view of an electric hair clipper according to an embodiment of the present invention in which casing 1 (FIG. 2) is provided as a structure that can be gripped by the hand, and in which blade block 5 is provided at the end of casing 1 through head portion 4. The casing 1 of the present invention may be any shape, and in the present embodiment is cylindrically shaped. As shown in FIG. 1, blade block 5 is equipped with comb-type stationary blade 51 and oscillating blade 52 that together form the leading edge of blade block 5. Cam 9 is an integral part of oscillating blade 52, and together with blade 52 forms oscillating blade block 16. Cam 9 may be a separately formed piece connected to oscillating blade 52. Alternatively, cam 9 may be formed unitarily and in one piece with the oscillating blade 52. Blade stop spring 15 provides for secure installation of blade block 5 to head portion 4.

Casing 1 includes split cases 2 and 3 that enclose oscillation generator 6, batteries 14, and circuit board 13. Sliding switch key 11 is provided on the external surface of casing 1 and moves switch plate 12, to which a contact spring has been soldered, to open or close the electrical contact points on circuit board 13.

Drive member 22 includes first drive element 22a and second drive element 22b. Drive member 22 is attached to oscillation generator 6 as the output part thereof, and drive pin 8, which extends outward from drive element 22a, is inserted into slot 10 which is part of cam 9, thus forming a structure that directly connects oscillating blade 52 to oscillation generator 6. The operation of oscillation generator 6 is thereby able to impart an oscillating movement to blade 52 which reciprocates against stationary blade 51 with the same oscillating action as drive member 22.

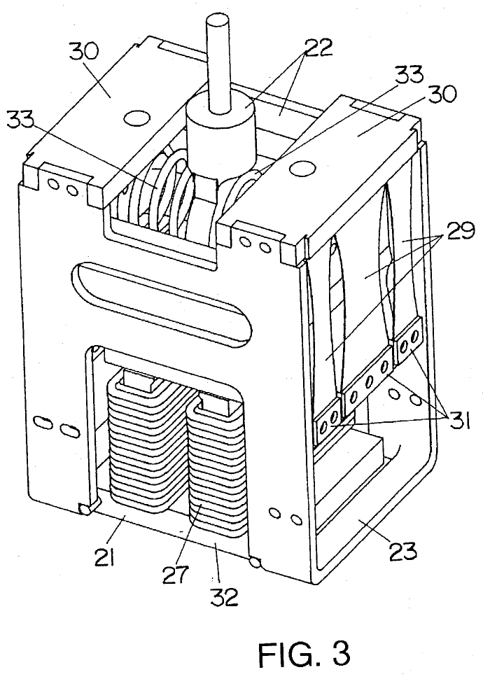

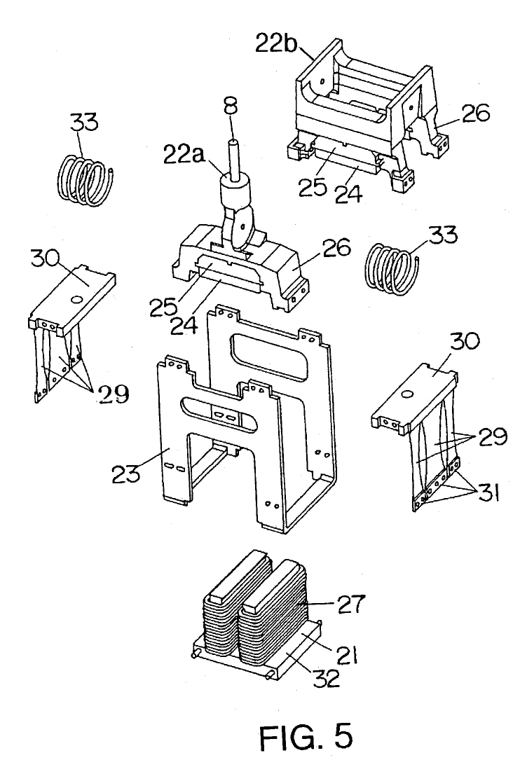

As shown in FIGS. 3-5, oscillation generator 6 includes frame 23, fixed member 32 which may be connected to frame 23 by any suitable connecting device such as, for example, welding or screws, a pair of oscillation-generating drive elements 22a, 22b, connecting members 29 that connect drive member 22 to frame 23, and springs 33 that are suspended between drive element 22a and drive element 22b. Each drive element 22a, 22b includes frame member 26 which incorporates permanent magnet 24 and back yoke 25 as integral components. Permanent magnet 24 may be connected to back yoke 25 by any suitable connecting device such as, for example, by welding. Back yoke 25 includes a magnetic material.

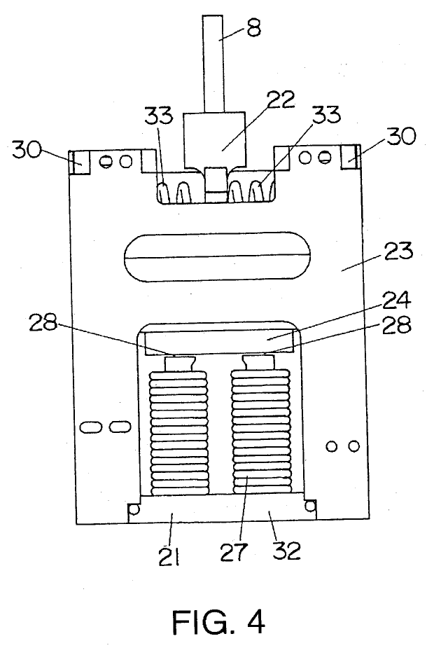

Fixed member 32 is an electromagnet comprised of ferrous core 21 around which wire 27 is wound. Core 21 may be formed in any suitable manner such as, for example, a layered assembly of magnetic steel plates or a sintered structure of magnetic material. As shown in FIG. 4, gap 28 is provided between the upper surface of ferrous core 21 and permanent magnet 24 which is attached to drive member 22.

Because connecting members 29 maintain drive member 22 in a position opposite to but not in contact with fixed member 32 through gap 28, the connecting members 29 preferably are made from an elongation-resistant elastic material. The top ends of connecting members 29 are attached to frame 23 through support plate 30, and the bottom ends to drive member 22 through support plates 31, thereby creating a structure through which drive member 22 is suspended within frame 23 by connecting members 29.

By installing spring 33 along the oscillating axis of drive members 22 between the inner surface of box-shaped drive element 22b and the other internally located drive element 22a, a structure is formed that stabilizes the oscillating frequency of connecting members 29 and drive member 22 as a result of the energy applied by spring 33 to drive member 22.

To further explain the operation of this type of block-shaped oscillation generator 6, when current is run through windings 27 of magnetic fixed member 32, drive member 22 moves as a result of the attracting and opposing forces that operate between permanent magnet 24 and the electromagnet. When the current flow direction is reversed, drive member 22 moves in the opposite direction which is restricted by connecting members 29. If an alternating current is run through the magnet, drive elements 22a, 22b oscillate in direct reaction to that current, thus the oscillating movement is induced from an oscillating type linear motor structure that eliminates the need for mechanical components to convert a rotating motion into an oscillating motion. Moreover, as drive member 22 is not in physical contact with fixed member 32, less noise is generated compared to that produced by a conventional structure in which the drive member slides against the fixed member. Furthermore, the non-contact structure described above offers a longer service life.

A structure may also be construed in which fixed member 32 is not secured to frame 23, and in which the block consisting of drive member 22, connecting members 29, and frame 23 is attached to casing 1. Rather, fixed member 32 may be attached to casing 1.

While this embodiment describes a structure that uses two drive elements 22a, 22b, drive pin 8, which connects to oscillating blade block 16, is attached to only one drive member 22a. Because the drive element 22b not attached to drive pin 8 suppresses the undesired oscillations produced by oscillator generator 6, the drive element 22a attached to drive pin 8 and the drive element 22b not attached to drive pin 8 oscillate in mutually opposing phase.

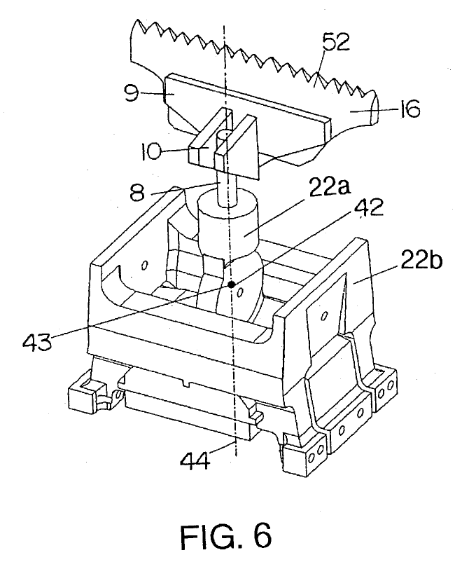

This structure makes it is possible to prevent casing 1 from vibrating in the oscillating direction by establishing the combined weight of oscillating blade block 16 and the drive element 22a that drives blade block 16 to a weight approximately equivalent to that of the drive element 22b that does not drive blade block 16, by locating the combined center of mass 42 of blade block 16 and drive element 22a that drives blade block 16 at the same point as that of center of mass 43 of the drive element 22b that does not drive blade block 16 (see FIG. 6), and by locating center of mass 42 and 43 along axial center 44 of casing 1.

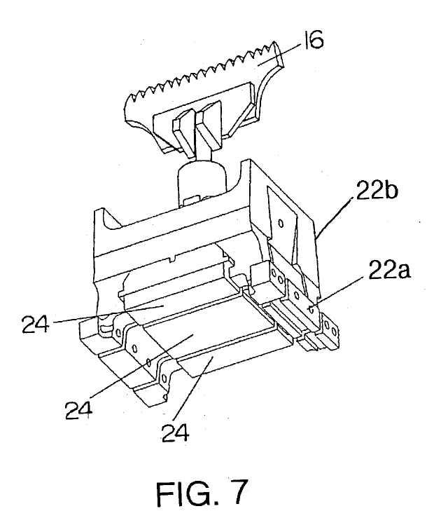

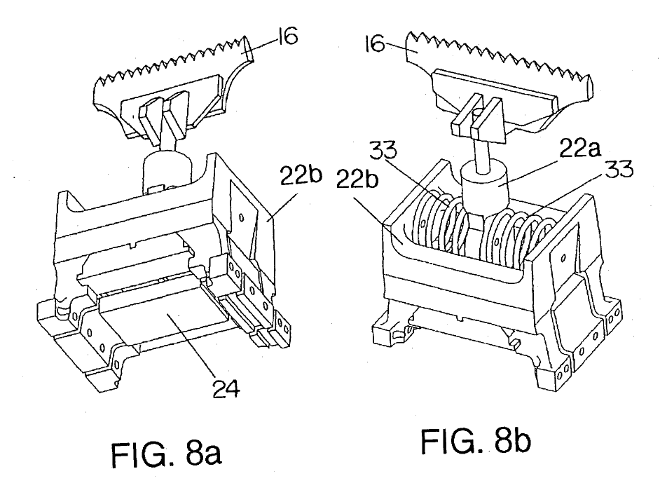

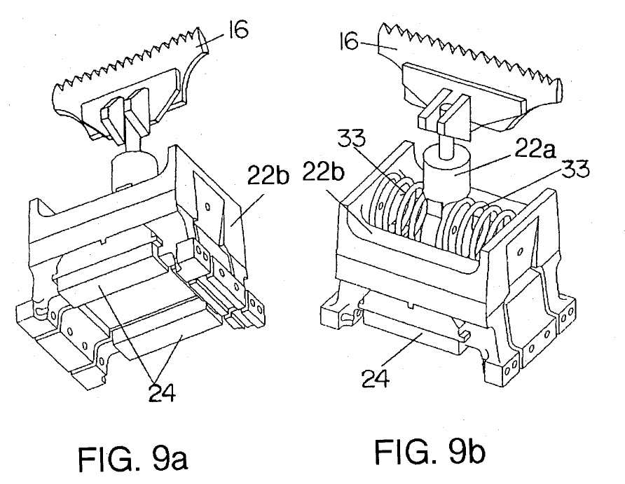

Also, as shown in FIG. 7, while the above-described embodiment describes a structure in which permanent magnets 24 are attached to both drive elements 22a, 22b, drive elements 22a, 22b may be joined by springs 33 in a structure, as shown in FIGS. 8b and 8b, in which permanent magnet 24 is attached only to the drive element 22a that drives oscillating blade block 16 and not to the drive element 22b that does not drive blade block 16. As shown in FIGS. 9a and 9b, drive elements 22a, 22b may also be connected by springs 33 in a structure in which a permanent magnet is not attached to the drive element 22a that drives blade block 16, but is attached to the drive element 22b that does not drive blade block 16.

Still further, both drive elements 22a, 22b may be structured so as not to oscillate in opposing phase. For example, drive elements 22a, 22b may be structured to oscillate in phase or slightly out of phase. This can be done by varying the strength of permanent magnets 24 installed to drive elements 22a, 22b.

The role of springs 33 may also be performed by forming connecting members 29 from elastic material, for example, as leaf springs. Thus, springs 33 may be omitted.

The present invention incorporates an oscillating blade driven by an oscillation generator that produces a reciprocating oscillating movement. Because the oscillating blade is driven by a mechanism which does not require that space be provided for power conversion components, the hair cutting device can be made to more compact dimensions and is able to operate with reduced power transmission loss.

Specifically, the direct connection of the oscillating blade to the oscillation generator provides for increased power transmission efficiency.

Furthermore, the oscillation generator is equipped with a first drive element joined to the oscillating blade, and a second drive element that is not joined to the oscillating blade, thus forming a structure that allows the two drive members to oscillate in the same direction but in dissimilar phase, and thus creating a mechanism able to provide the advantageous effect of suppressing undesirable oscillations.

Moreover, undesirable oscillations can be reduced by establishing the weight of the second drive element to a weight approximately equivalent to the combined weight of the first drive element and oscillating blade, and by locating the center of mass of the structure including the first drive element and oscillating blade at the approximate center of mass of the second drive element. The transfer of undesirable oscillations to the casing in which the oscillation generator is provided can be substantially reduced by locating the center of mass of the structure including the first drive element and oscillating blade and the center of mass of the second drive element on the axial center of the casing. Compared to conventional electric hair clippers, the hair clippers of the present invention are more comfortable to operate for the person gripping the casing as a result of the substantially reduced casing vibration.

Furthermore, the structure through which both drive members are connected by springs located along the oscillating direction has the effect of stabilizing the oscillation frequency, thus increasing the shearing effectiveness of the blade block under a high load condition induced by a large amount of hair entering the region between the blades, and has the further desirable effect of providing a smoother shearing action. Also, there is no change in the noise emitted by the hair clippers as a result of the stable oscillation frequency when the blades are operating under a fluctuating load.

The manufacturing cost of the hair clippers can be reduced by utilizing only one drive member as the magnetically driven drive member.

Moreover, by attaching the drive members to a fixed part through connecting members that allows the drive members to oscillate in dissimilar phase, the drive members can be maintained in a position not in contact with the fixed member, thus providing for an effective shearing action, reduced noise, and increased service life.

Although the invention has been described with reference to an exemplary embodiment, it is understood that the words that have been used are words of description and illustration, rather than words of limitation. Changes may be made, within the purview of the appended claims, as presently stated and as amended, without departing from the scope and spirit of the present invention in its aspects. Although the invention has been described herein with reference to particular means, materials and embodiments, the invention is not intended to be limited to the particulars disclosed herein. Instead, the invention extends to all functionally equivalent structures, methods and uses, such as are within the scope of the appended claims.

The present disclosure relates to subject matter contained in priority Japanese Patent Application No. 2002-022476, filed on Jan. 30, 2002, which is herein expressly incorporated by reference in its entirety.

What is claimed is:

1. An electric hair clipper comprising:
a hair shearing mechanism including a comb-shaped stationary blade and an oscillating blade that reciprocates along and in contact with a surface of said stationary blade; and
a magnetic oscillation generator that transfers oscillating movement to a drive member connected to said oscillating blade.

2. The electric hair clipper according to claim 1, wherein said oscillating blade is directly attached to said drive member of said oscillation generator.

3. The electric hair clipper according to claim 1, said drive member comprising:
a first drive element connected to said oscillating blade; and
a second drive element not connected to said oscillating blade;
wherein said oscillation generator generates oscillating movement in which said first and second drive elements oscillate in the same direction but in dissimilar phase.

4. The electric hair clipper according to claim 3, wherein said second drive element is configured to have sufficient weight to minimize oscillation transmitted to a casing of the hair clipper.

5. The electric hair clipper according to claim 3, wherein said first and second drive elements oscillate in mutually opposing phase.

6. The electric hair clipper according to claim 5, wherein the combined weight of said first drive element and said oscillating blade substantially equals the weight of said second drive element.

7. The electric hair clipper according to claim 6, wherein the combined center of mass of said first drive element and said oscillating blade and the center of mass of said second drive element are both located at substantially the same position.

8. The electric hair clipper according to claim 7, wherein the combined center of mass of said first drive element and said oscillating blade and the center of mass of said second drive element are both located on an axial center of the casing housing said oscillation generator.

9. The electric hair clipper according to claim 3, further comprising:
springs connecting said first and second drive elements and oriented in the oscillating direction of said oscillating blade.

10. The electric hair clipper according to claim 9, wherein at least one of said first and second drive elements comprises at least one magnetically driven drive member.

11. The electric hair clipper according to claim 3, wherein said first and second drive elements are provided on a fixed member through at least one connecting member, said at least one connecting member providing a mechanism through which said first and second drive elements may oscillate in the same direction but in dissimilar phase.

12. The electric hair clipper according to claim 3, further comprising:
a slot provided on a face of said oscillating blade; and
a drive pin extending from said first drive element and configured to fit into said slot, wherein said first drive element transfers oscillating movement to said oscillating blade.

13. The electric hair clipper according to claim 1, said oscillation generator further comprising:
a fixed member including an electromagnet;
a frame provided on said fixed member; and
said drive member comprising:
a first drive element connected to said oscillating blade;
a second drive element, said second drive element configured to have a substantially box shape, and said first drive element positioned internally of said box shaped second drive element;
connecting members that connect said first and second drive elements to said frame, said connecting members maintaining a gap between said first and second drive elements and said electromagnet; and
a pair of springs provided suspended between said first and second drive elements and oriented in the oscillating direction of said oscillating blade.

14. The electric hair clipper according to claim 13, wherein said connecting members are constructed of an elongation resistant elastic material.

15. The electric hair clipper according to claim 13, further comprising:
a pair of support plates provided on said frame, wherein bottom ends of said connecting members are connected to said frame and top ends of said connecting members are connected to said support plates so that said first and second drive elements are suspended in said frame by said connecting members.

16. The electric hair clipper according to claim 13, said first drive element further comprising a permanent magnet, said connecting members maintaining said gap between said electromagnet and said permanent magnet.

17. The electric hair clipper according to claim 13, said second drive element further comprising a permanent magnet, said connecting members maintaining said gap between said electromagnet and said permanent magnet.

18. A method of increasing efficiency an electric hair clipper and minimizing noise and vibration observed by a user of the electric hair clipper, comprising:
providing an electric hair clipper having a hair shearing mechanism including a comb-shaped stationary blade and an oscillating blade that reciprocates along and in contact with a surface of said stationary blade;
providing a magnetic oscillation generator; and
transferring oscillating movement to a drive member connected to said oscillating blade by said magnetic oscillation generator.

19. The method according to claim 18, further comprising attaching said oscillating blade directly to said drive member of said oscillation generator.

20. The method according to claim 18, further comprising providing said drive member with a first drive element connected to said oscillating blade and a second drive element not connected to said oscillating blade; and
generating oscillating movement by said oscillation generator such that said first and second drive elements oscillate in the same direction but in dissimilar phase.

21. The method according to claim 20, further comprising configuring said second drive element to have sufficient weight to minimize oscillation transmitted to a casing of the hair clipper.

22. The method according to claim 20, further comprising oscillating said first and second drive elements in mutually opposing phase.

23. The method according to claim 22, further comprising configuring said first drive element, said oscillating blade and said second drive element such that the combined weight of said first drive element and said oscillating blade substantially equals the weight of said second drive element.

24. The method according to claim 23, further comprising locating the combined center of mass of said first drive element and said oscillating blade and the center of mass of said second drive element at substantially the same position.

25. The method according to claim 24, further comprising locating the combined center of mass of said first drive element and said oscillating blade and the center of mass of said second drive element on an axial center of the casing housing said oscillation generator.

26. The method according to claim 20, further comprising connecting said first and second drive elements with springs, and orienting the springs in the oscillating direction of said oscillating blade.

27. The method according to claim 18, further comprising configuring at least one of said first and second drive elements to have at least one magnetically driven drive member.

28. The method according to claim 20, further comprising providing said first and second drive elements on a fixed member through at least one connecting member to permit said first and second drive elements to oscillate in the same direction but in dissimilar phase.
